(19) United States
(12) Patent Application Publication
(10) Pub. No.: US 2011/0036654 A1
(43) Pub. Date: Feb. 17, 2011

(54) MOULDED PLASTIC PART FOR ACCOMMODATING A VEHICLE BATTERY

(75) Inventors: Jürgen Rinderlin, Vorstetten (DE); Frank Hoecker, Dornstadt (DE); Ulrich Uhl, Aalen (DE)

Correspondence Address: URSULA B. DAY, ESQ., 708 Third Avenue, SUITE 1501, NEW YORK, NY, 10017, US

(73) Assignee: Peguform GmbH, Botzingen (DE)

(21) Appl. No.: 12/675,631

(22) PCT Filed: Aug. 20, 2008
(86) PCT No.: PCT/EP2008/006827

§ 371 Date: Aug. 20, 2010

(30) Foreign Application Priority Data
Aug. 30, 2007 (EP) 07016987.5

(51) Int. Cl. B60R 16/04; B29C 45/00; B29C 43/00; B29C 47/00; B29C 70/00

(52) U.S. Cl. 180/68.5; 264/271.1

(57) ABSTRACT

A moulded plastic part for accommodating at least one vehicle battery, said moulded plastic part being reinforced by one or more inserts and having at least one further functional device which is moulded onto the moulded plastic part directly during the shaping process.

The present invention refers to a plastic molded part for receiving at least a vehicle battery having features as recited in the preamble of claim 1.

In order to accommodate a vehicle battery, vehicle construction provides a variety of holding wells. In particular, wells for batteries for trucks are especially subjected to heavy stress, since they normally are disposed unprotected at the vehicle frame in proximity to the wheels of the vehicle. Such wells are subjected to spraying water, dirt and stones, as well as mechanical stress, as for example, vibrations from the vehicle frame. Since such wells are additionally supposed to carry out a protective function for the battery itself, to date, such wells are constructed as steel plate constructions in order to withstand the extraordinary stresses. One of the drawbacks of such constructions is the heavy weight of such battery wells.

Battery wells are also known which are manufactured from plastic in a relatively simple manufacturing process. Such a well is, for example, described in DE 199 61 853 C1, the subject of which is a well of fiber reinforced plastic. In particular, wells for truck batteries are wells that are entirely made from thermoplastic material and are only suitable to a limited extent. Thus, the requirements for mechanical properties of a well for a truck battery are such that they cannot be fulfilled with a fiber reinforced plastic alone.

In 10 2005 054 764 B3, wells for the placement of a vehicle battery are described in which the mechanical properties were improved by means of inserts from preformed fiber networks.

Since the battery wells are normally connected directly to the vehicle frame of the truck, high oscillations and vibrations are transmitted to the battery well from the vehicle frame. As a result, the points at force transmission, or the points where the well is attached to a part of the vehicle frame, incur an enormous mechanical stress at the well so that additional reinforcement is required. By these means, the effective forces are to be absorbed and are to be introduced via full contact into the molded part in order to prevent tearing of the plastic structure. By means of inserts, it is thus possible to increase the stability of the molded part or the battery well such that the original sheet metal well can be replaced by a markedly lighter plastic well.

The known plastic wells have, however, the drawback that additional functional devices which were originally attached to the sheet metal well by either screwing or welding, are now absent.

It is thus an object of the present invention to provide plastic molded parts to accommodate at least one vehicle battery, in particular, for a truck, without the drawbacks of the battery wells in the prior art.

This object is solved by providing a plastic molded part having the features as recited in claim 1. Advantageous embodiments are subject of the dependent claims.

The plastic molded part according to the present invention is manufactured by means of a conventional molding process, such as for example injection molding, pressing, extrusion or an extrusion strand deposit process, wherein the following plastic components are considered for the matrix plastic materials, selected from the group of fiber reinforced poly propylene (PP), fiber reinforced polyethylene (PE), fiber reinforced polyamide (PA), sheet molding compounds (SMC) as well as glass fiber mat thermoplasts (GMT) on the basis of polypropylene, polyethylene or polyamide. As fiber reinforcements of the plastic matrix, glass fibers, carbon fibers, metal fibers, nylon or also textile natural fibers can be utilized, wherein the fibers can be provided in unidirectional, woven or random orientation.

The stability in the plastic molded parts required for example when used as battery wells for trucks, is realized by means of embedding at least one, preferably several inserts (hybrids). For inserts, or hybrids, woven mats or steel sheets are utilized, which during molding are pressed around or are extrusion coated with the matrix. Preferred are inserts which are placed locally in areas of especially heavy wear of the molded part, such as for example at the corners or edges, but are also utilized in the area of the larger surfaces, wherein the inserts may be disposed at the molded part exteriorly, centrally at the part, or interiorly. An advantageous embodiment provides that the plastic molded part in the insert is itself preformed, so that the reinforcement, after incorporating the insert, extends over the entire plastic molded part. In this manner, it is possible to obtain molded parts with an extraordinarily high mechanical stability, which, despite their extreme stability are of markedly lower weight as compared to the conventional steel plate or steel sheet constructions. Thus, the weight of conventional battery wells, which are constructed from a number of single sheet metal parts into a single component, is about 45 kg, while a hybrid reinforced plastic molded part with the same functions, weighs only about 12 kg.

An important role as well component are also the attachment devices for attaching the battery well to the vehicle, which are formed directly onto the plastic molded part in the form of threaded inserts or sheet metal reinforcements that are able to withstand high stress thus permitting a durable screw connection, whereby preferably metal meets metal, and to thereby realize an optimal force transmission into the side walls.

Essential to the invention is that the plastic molded part, aside from its function as a well for a vehicle battery, also includes at least one, preferably several additional functional devices, which are formed directly in the plastic molded part, during the molding process. In this manner, the additional functional device(s) can be directly formed at the matrix of the molded part or they are formed at the molded part as inserts by means of the afore-described hybrids, wherein naturally also those inserts are selected or suitable which are embedded as reinforcements in the matrix.

Functional devices are all those that represent any function related to the field of battery wells, such as for example providing bearing surfaces or mounting aids for fuel tanks, holding devices for cables, attachment devices for covers, valves, distributors or tanks, floor openings for dirty water, anti-slip devices, or also positioning aids for the batteries.

In further advantageous embodiments, the battery well is provided with anti-slip mats or anti-slip devices, which are for example press coated or extrusion-coated with the plastic material of the plastic molded part.

Advantageous embodiments of the present invention provide that textile mats of glass fiber strands are utilized as local reinforcements alone or in combination with sheet metal reinforcements. As inserts, sheet metal, semi-finished fiber products, textile layers or non-woven layers are especially contemplated.

Further advantageous embodiments of the present invention provide inserts that possess the basic form of the plastic molded part to be produced, and also include devices for additional functions. As already afore-described, in this manner, plastic molded parts are realized that are extraordinarily mechanically solid and in addition, provide functional devices.

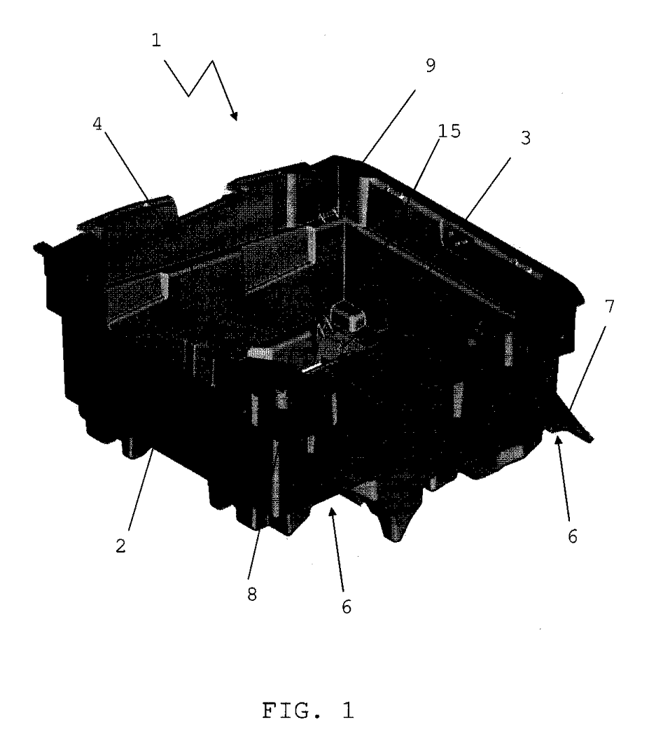

Following are a detailed description of several preferred embodiments of the present invention as represented in FIGS. 1 to 5.

FIG. 1 shows a top side view of a perspective illustration of a battery well;

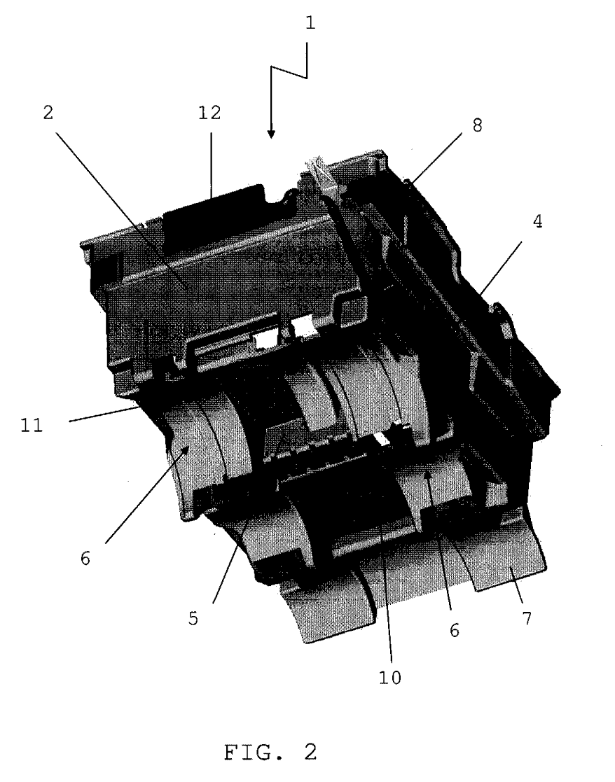

FIG. 2 shows a bottom view of a perspective illustration of a battery well;

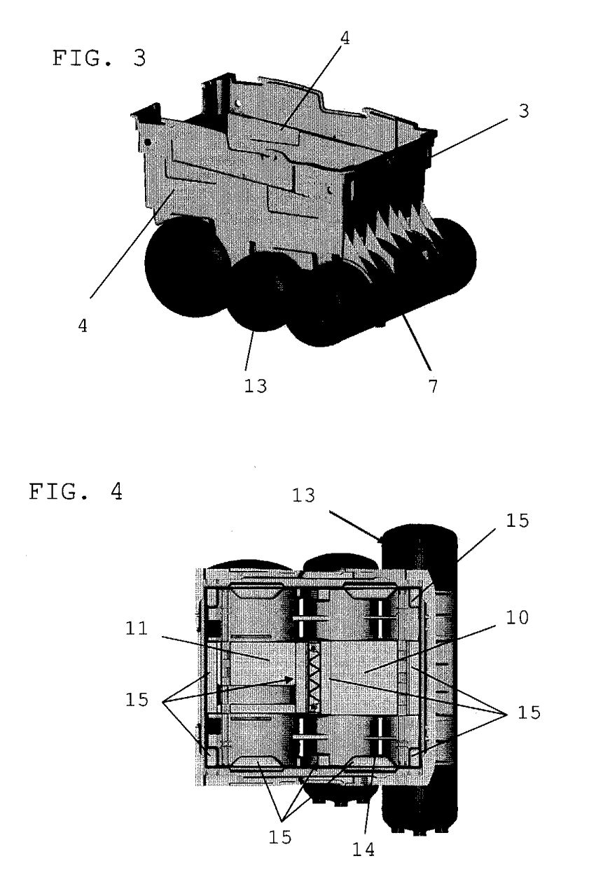

FIG. 3 shows a perspective illustration of a battery well with added containers placed at the bottom;

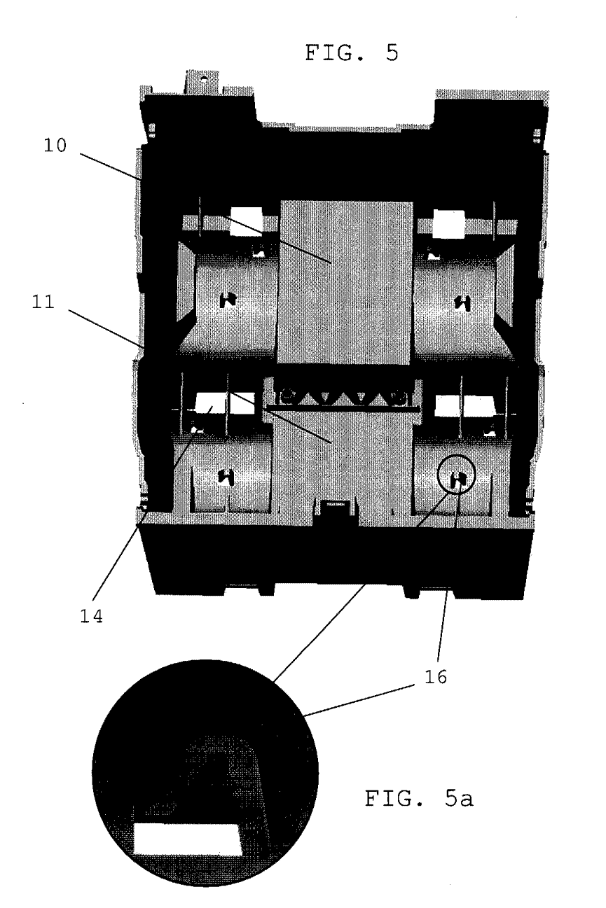

FIG. 4 shows the well of FIG. 3 in a top view;

FIG. 5 shows the top view of a battery well; and

FIG. 5a shows a detail of FIG. 5.

FIG. 1 shows a hybrid reinforced battery well 1 with a leading front wall 2, a rear end wall 3 as well as two side walls 4. Integrated into floor 5, which in the shown illustrations is not seen, are receiving surfaces 6 for container 13, whereby the receiving surfaces 6 of battery well 1 are integrally formed with the container 13. In order to extend the spatial capacity of the bottom area of the battery well 1, a spoiler 7 is formed at the well as a quasi extension of the rear end wall 3, which is provided also as a take-up surface for container 13. The corners of battery 1 are exteriorly reinforced with inserted sheet metal 8 and formed directly into the battery well 1 during the molding process (injection molding), or are retroactively installed. On the interior side, at the level of the sheet metal reinforcement 8, an opening reinforcement 9 is seen, which is advantageously also directly formed during the molding process. Through the reinforcements 8 and 9 that are configured to absorb extremely high stress, a solid screwed connection of the battery well 1 at the vehicle is realized. The reinforcements 8 and 9 are provided as additional local reinforcements to the reinforcements that are realized through the inserts placed in the well itself. Specifically, textile mats or sheet metal, not shown in the present illustration, that are provided as inserts are being form-coated, press-coated or extrusion-coated during the molding process. Inserts or hybrids are able to partially reinforce all areas of the battery well 1. An advantageous embodiment provides that the entire basic body of the battery well 1 is being textile- or steel sheet reinforced.

FIG. 2 shows a perspective illustration of the battery well 1 in the bottom view. In this illustration, the supporting surfaces 6 for container 13 that are integrated into the well floor 5 are easily seen. In the bottom area 10 of the battery well 1, the rear walls of support surfaces 10 and 11 for the batteries are seen. In the corner area, the sheet metal reinforcement 8 is again seen, which is either directly formed during the molding process or is mounted subsequently.

FIG. 3 shows in a perspective view the battery well 1 with containers 13 that are supported by means of the support surfaces 6 of the battery well 1. In the area of rear end wall 3 of battery well 1, the spoiler 7 expands the support surface 6 for container 13 beyond the battery well 1. The spoiler 7 is reinforced by means of additional reinforcement ribs, which are disposed between the spoiler 7 and the rear end wall 3.

FIG. 4 shows the battery well 1 of FIG. 3 with supported containers 13 in the top view. The support surfaces 10, 11 and 15 for the battery are configured in different sizes and are adjustable to the respective size of the battery they seat. In FIG. 4, a multitude of support surfaces 10, 11 and 15 are seen that are positioned and selected such that one or more batteries of different sizes can be positioned in the battery well 1, without the need to employ additional tools. From this perspective view, it can also be seen that between the support surfaces 6 for the container 13, in the floor area of battery well 1, openings are provided that are essentially there to allow drainage of dirty water.

FIG. 5 shows the battery well 1 approximately from the same perspective as FIG. 4 and varies from FIG. 4 essentially only in that one or several additional functional devices are formed at the battery well 1. Thus, at the rear wall of support surfaces 6 contemplated for container 13, clamps are provided that are directly formed at the battery well 1 and provided as attachment clamps 16 for the straps or bands to mount container 13. The clamps 16 facilitate a simple way of mounting container 13 and avoid most of all that the strap or band falls down during mounting.

### REFERENCE NUMERALS

1 battery well

2 leading end wall

3 rear end wall

4 side wall

5 bottom

6 support surface container

7 spoiler container

8 sheet metal reinforcement

9 reinforcement ring

10 support surface battery

11 support surface battery

12 reinforcement

13 container

14 floor opening

15 support surface battery

16 clamp

1. Plastic molded part for receiving at least a vehicle battery for a vehicle having attachment points for attaching the plastic molded part at the vehicle, wherein the plastic molded part is made from a pre-impregnated semi-finished fiber-matrix form and reinforced with at least one insert, wherein the plastic molded part includes at least one further functional device, which was formed at the plastic molded part during the molding process.

2. Plastic molded part according to claim 1, wherein additional functional devices are directly formed at the plastic matrix.

3. Plastic molded part according to claim 2, wherein additional functional devices are formed at the molded part by means of an insert.

4. Plastic molded part according to claim 1, wherein the at least one further device comprises support surfaces (6) and/or assembly aids for tank containers, holding devices for cables, attachment devices for covers, valves, distributors or tanks, clamps (16), floor openings (14) for dirty water, anti-slip devices or positioning aids and support surfaces (15) for batteries.

5. Plastic molded part according to claim 4, wherein the attachment device in form of threaded inserts or sheet metal reinforcements (8) are directly formed at the plastic molded part.

6. Plastic molded part according to claim 4, wherein the anti-slip devices such as for example anti-slip mats are press coated or extrusion coated with the plastic of the plastic molded part.

7. Plastic molded part according to claim 1, wherein the plastic molded part is manufactured by a molding process for plastic selected from the group of injection molding, pressing, extrusion or strand deposit process.

8. Plastic molded part according to claim 1, wherein the plastic component for the molding process comprises plastic material selected from the group of fiber reinforced poly propylene (PP), fiber reinforced polyethylene (PE), fiber reinforced polyamide (PA), sheet molding compounds (SMC) as well as glass fiber mat thermoplasts (GMT) on the basis of polypropylene, polyethylene or polyamide.

9. Plastic molded part according to claim 1, wherein the fibers for the fiber reinforcement of the plastic matrix are glass fibers, carbon fibers, metal fibers, nylon and textile natural fibers, wherein the fibers that are utilized are provided in unidirectional, woven or random orientation.

10. Plastic molded part according to claim 1, wherein local reinforcements, textile mats or glass fiber mats alone or in combination with sheet metal reinforcements (8) are utilized.

11. Plastic molded part according to claim 1, wherein the at least one insert is from sheet metal.

12. Plastic molded part according to claim 1, wherein at least one insert is a fiber preform, textile layer or a fleece layer.

13. Plastic molded part according to claim 1, wherein at least one insert corresponds to the basic form of the plastic molded part.
